(19) United States
(12) Patent Application Publication
(10) Pub. No.: US 2016/0369970 A1
(43) Pub. Date: Dec. 22, 2016

(54) LIMITED ELECTROMAGNETIC RADIATION MOTOR VEHICLE LIGHTING DEVICE

(71) Applicant: Valeo Vision, Bobigny Cedex (FR)

(72) Inventors: Erwan Faoucher, Avrille (FR); Michel Hermitte, Angers (FR); Francois Gratecap, Beaucouze (FR); Michel Juton, Varades (FR)

(21) Appl. No.: 15/187,955

(22) Filed: Jun. 21, 2016

(30) Foreign Application Priority Data
Jun. 22, 2015 (FR) 1555682

(51) Int. Cl. F21S 8/10

(52) U.S. Cl. CPC F21S 48/30

(57) ABSTRACT

A motor vehicle lighting device, comprising at least one electric element and at least one first wall delimiting an area on which or in which the electric element is retained, this first wall being at least partly covered with an electrically conductive coating forming electromagnetic shielding.

### CROSS-REFERENCE TO RELATED APPLICATIONS

This application claims priority to the French application 1555682 filed Jun. 22, 2015, which applications are incorporated herein by reference and made a part hereof.

### BACKGROUND OF THE INVENTION

1. Field of the Invention

The present invention concerns the technical field of motor vehicle lighting devices. The invention more particularly concerns an electromagnetically shielded motor vehicle lighting device provided with.

2. Description of the Related Art

A motor vehicle generally includes lighting devices forming various lighting or signaling lights. A lighting device notably includes a light source emitting a light beam and various optical elements. In order to connect this light source to electrical power supply means and/or to control means, the lighting device generally includes for this purpose a plurality of electric conductors, notably electric cables.

However, the current flowing in the electric cables generates a radiated electromagnetic field that propagates in the lighting device and to the exterior thereof. This electromagnetic field is liable to interfere with the electric, notably electronic, devices with which the motor vehicle is generally equipped.

In order to reduce the power of the electromagnetic field radiated from the lighting device it is known to optimize the arrangement of the electric cables in the lighting device in order to minimize the power of the electromagnetic field radiated from the lighting device. However, the power of the electromagnetic field radiated inside and from the lighting device can remain inconveniently high.

To alleviate this problem, one known solution is to provide the electric cables with metal sheaths to form so-called screened cables. In fact, the metal sheaths form electromagnetic shielding able to limit or even to prevent the propagation of the electromagnetic fields emitted by the electric cables to the outside of the shielding. In other words, the metal sheaths form Faraday cages inside which the electromagnetic fields emitted by the electric cables are confined. The manufacture and the fitting of such metal sheaths are costly, however.

### SUMMARY OF THE INVENTION

An object of the invention is to limit the electromagnetic fields emitted by the cables in and outside the lighting devices employing means of relatively low cost that are simple to install.

To this end, there is provided in accordance with the invention a motor vehicle lighting device comprising at least one electric element and at least one first wall delimiting an area on which or in which the electric element are retained, this first wall being at least partly covered with an electrically conductive coating forming electromagnetic shielding.

By electromagnetic shielding is meant the function of reflection and/or absorption of the electromagnetic fields. In other words, the electrically conductive coating is able to reflect and/or to absorb the magnetic fields emitted in the direction of this coating.

The first wall of the lighting device being covered with an electrically conductive coating, the electromagnetic fields emitted by the electric element encountering the first wall are therefore reflected and do not pass through the first wall. As a result, the magnetic fields diffused by the electric element outside the lighting device are limited. Moreover, given that it suffices to provide one wall of the lighting device with an electrically conductive coating, it is clear that the invention is simpler to implement and less costly than the prior art solutions referred to above.

The electric element advantageously includes an electric conductor.

In the context of the present invention, there is meant by “electric conductor” one or more elongate electrically conductive element(s) surrounded by at least one electrically insulative layer, the electrically insulative layer optionally being in direct physical contact with the elongate electrically conductive element or elements.

The electric conductor conventionally has a longitudinal axis.

The elongate electrically conductive element of the electric conductor of the invention is conventionally intended to distribute electric current between different electric devices, notably to distribute electric current to at least one lighting device of the motor vehicle. More particularly, the electric conductor of the invention is intended to be connected, or is connected, to at least one lighting device of the motor vehicle.

The elongate electrically conductive element of the electric conductor may typically be a metal wire or a plurality of metal wires, optionally twisted, notably of copper and/or aluminum (of zero degree oxidation), or one of their alloys. The elongate electrically conductive element of the electric cable is preferably of copper (of zero degree oxidation).

By way of one embodiment, the electric conductor may comprise one or more insulated electric wire(s), optionally surrounded by a protective sheath.

The coating is advantageously transparent to visible light.

Visible light is considered to correspond to electromagnetic fields the wavelength of which is between 380 and 750 nm inclusive.

The optical means of the lighting device can therefore be coated without impeding the propagation of light in the lighting device, which could facilitate the process of depositing the coating in some cases.

The coating advantageously comprises at least one metal oxide.

The at least one metal oxide is preferably transparent.

The at least one metal oxide advantageously includes the following substances, separately or in combination:
zinc oxide doped with aluminum AZO;
indium tin oxide ITO;
zirconium oxide ZrO₂;
tantalum oxide Ta₂O₅;
tin oxide doped with antimony ATO.

The coating preferably comprises at least one organic binder for binding together the oxide. The organic binder may consist of one or more transparent electrically conductive polymers. The transparent electrically conductive polymers comprise the following polymers, separately or in combination:
phenylene polysulfide (PPS);
PEDOT: PSS.

This coating substance enables the coating to have a satisfactory electrical conductivity enabling the electromagnetic shielding and to be of relatively low cost.

The coating advantageously has a thickness less than 10 μm.

The coating is therefore not too thick, which would reduce its mechanical strength. This ensures the mechanical durability of the coating.

The first wall is advantageously produced in a polymer covered by the coating.

The first wall is therefore light in weight and of relatively low cost.

In accordance with a first embodiment of the invention, the lighting device comprises a casing, the first wall being at least one part of the casing.

The wall of the casing covered with the coating therefore enables reflection of the electromagnetic fields emitted by the electric element. Moreover, it is not necessary to provide a part intended only to form the first wall, which would increase the overall size within the lighting device and would generate an additional cost linked to the manufacture of this part.

In accordance with a variant of the first embodiment of the invention, the lighting device comprises an electric connection substrate adapted to be connected to the electric element, the first wall being formed by this electric connection substrate.

An electric connection substrate may be a printed circuit board (PCB) and/or a flexible printed circuit board (FPCB) and/or a variable geometry interconnection device, notably of the MID (molded-in device) type.

The electric connection substrate carrying the electric element from which the electromagnetic fields are emitted, the substrate is situated in the immediate vicinity of the electric element. This proximity therefore enables it to reflect and/or to absorb the electromagnetic fields effectively. Moreover, and once again, it is not necessary here to provide a part intended only to form the first wall.

The electrical conductivity of the coating is advantageously greater than or equal to 1.10⁻³ S·m⁻¹, preferably greater than or equal to 0.1 S·m⁻¹, preferably greater than or equal to 1.0 S·m⁻¹ and especially preferably greater than or equal to 1.10³ S·m⁻¹.

This reduces the risk of short-circuits that could occur if the coating were to come accidentally into contact with an element of the lighting device that is electrically conductive, such as the electric element.

In accordance with a second embodiment of the invention, the electric element comprise at least one electric conductor and are retained at least in part on a guide element for guiding the path of the electric conductor, the first wall being at least in part formed by the guide element.

The guide element makes it possible to guide the electric conductor in the lighting device and to circumscribe it in a defined area of the lighting device so that it does not move much or at all when the vehicle is moving. A wall of the guide element being covered by the coating, and the guide element being situated in the vicinity of the electric conductor, the first wall reflects and/or absorbs the electromagnetic fields emitted by the electric conductor effectively.

The lighting device preferably comprises a second wall at least partly covered with an electrically conductive coating, the first wall being part of the guide element and the second wall being part of a portion of a casing of the lighting device, these first and second walls delimiting a confinement housing in which the electric conductor is retained.

Electromagnetic shielding is therefore provided against the electromagnetic fields emitted in all directions by the electric element situated in the confinement housing.

The optic unit advantageously comprises a plurality of electric element forming electric conductors, the first wall being common to these electric conductors.

The shape of the electromagnetic shielding is therefore independent of the number of electric element accommodated in the lighting device, which offers flexibility in the design of the lighting device.

The electric element is advantageously at least partly covered with an electrically conductive coating.

The electromagnetic fields emitted by the electric element are therefore further confined, because the electromagnetic fields are absorbed and/or reflected by the electrically conductive coating covering not only the first wall but also the electric element.

Moreover, by way of a variant embodiment, the first wall could not be covered with the electrically conductive coating and only the electric element covered therewith. This reduces the quantity of coating needed without this greatly reducing the effectiveness of the electromagnetic shielding, because the shielding is situated in the immediate vicinity of the electric element that emit the magnetic fields.

These and other objects and advantages of the invention will be apparent from the following description, the accompanying drawings and the appended claims.

### BRIEF DESCRIPTION OF THE ACCOMPANYING DRAWINGS

The invention will be better understood on reading the following description given by way of example only and with reference to the drawings, in which:

FIG. 1 is a perspective view of a motor vehicle lighting device in accordance with a first embodiment of the invention;

FIG. 2 is a diagrammatic view in section in a plane perpendicular to the direction of movement of the vehicle of the lighting device from FIG. 1;

FIG. 3 is a diagrammatic view in section in a plane perpendicular to the direction of movement of the vehicle of a lighting device in accordance with a variant of the first embodiment of the invention;

FIG. 4 is a perspective view of a motor vehicle lighting device in accordance with a second embodiment of the invention;

FIG. 5 is a diagrammatic view in section in a plane perpendicular to the direction of movement of the vehicle of the lighting device from FIG. 4;

FIG. 6 is a perspective view to a larger scale of a guide element of the lighting device from FIG. 4;

FIG. 7 is a perspective view of a motor vehicle lighting device in accordance with a variant of the invention applicable to the first and second embodiments of the invention; and

FIG. 8 is a perspective view to a larger scale of an electric element of the lighting device from FIG. 7.

### DETAILED DESCRIPTION OF THE PREFERRED EMBODIMENTS

There is used hereinafter an orthogonal frame of reference XYZ shown in FIGS. 2, 3 and 5 in which the horizontal axes X and Y are respectively parallel to and perpendicular to the direction of movement of the vehicle and the axis Z is vertical.

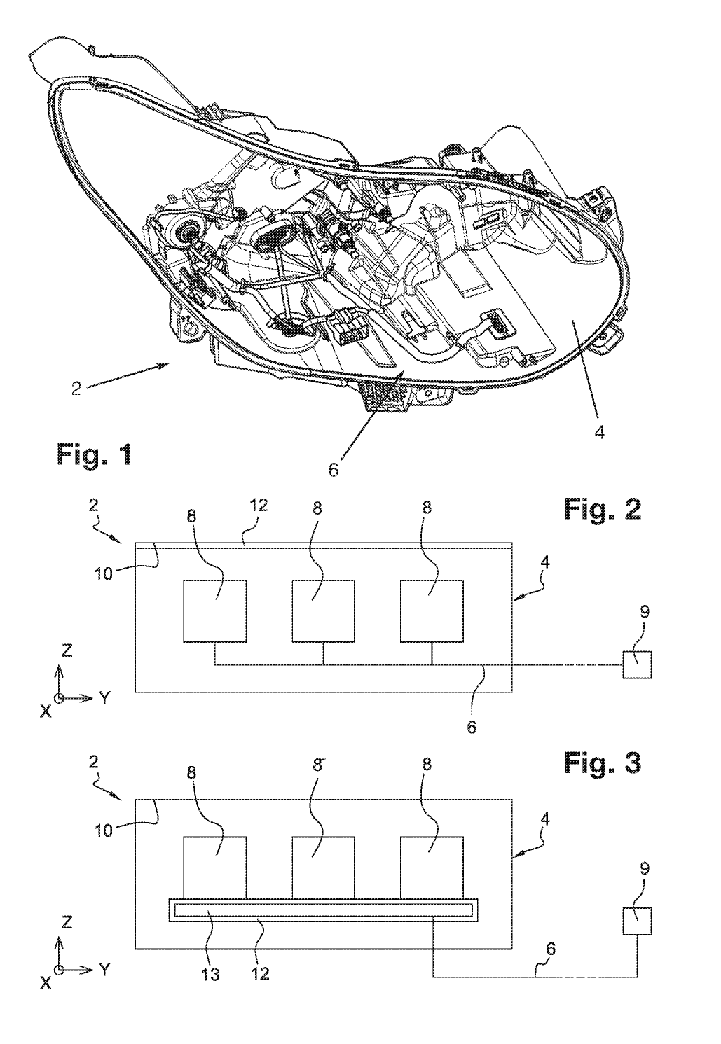

A motor vehicle lighting device 2 in accordance with a first embodiment of the invention is shown in FIGS. 1 and 2. This lighting device 2 comprises an open casing 4 made from a polymer material.

At least one electric element 6 and optical means 8 adapted to form a light beam are retained in the casing 4 of the lighting device 2. The electric means or element 6 comprises at least one electric conductor. The optical means 8 notably comprise at least one light source, generally a plurality of light sources. The electric element 6 is intended to connect the light sources to electrical power supply and/or control means 9 generally situated in the vehicle outside of the lighting device 2. In the present case, the electric element 6 comprises a plurality of electric conductors. They could be any other electric element, however.

The lighting device 2 also comprises a protective outer lens (not shown) closing the casing 4. This protective outer lens is transparent to the visible light emitted by the optical means 8. The light beam passes through the protective outer lens to light up the road in front of the vehicle.

In operation, the electric conductors 6 emit an electromagnetic field in all directions in space. This field is generated by the electric current that passes through the electric conductors 6.

Referring to FIG. 2, part of a first wall of the casing 4 delimiting an internal surface 10 of that casing 4 is provided with an electrically conductive coating 12. It is possible to cover all of the internal surface 10 with the coating 12.

The coating 12 is transparent to visible light, i.e. to electromagnetic fields the wavelength of which is between 380 nm and 750 nm inclusive. The coating 12 comprises at least one metal oxide. The coating 12 also comprises at least one organic binder for binding together the oxide. The transparency of the coating 12 means that if a portion of the coating 12 strays onto the protective outer lens during its deposition on the internal surface 10, that portion does not constitute an obstacle to the propagation of the light beam to the outside of the lighting device 2. The presence of the metal oxide makes it possible to render the coating 12 electrically conductive.

The electric conductivity of the coating 12 is greater than or equal to 1.10⁻³ S·m⁻¹ (Siemens per meter), preferably greater than or equal to 0.1 S·m⁻¹, preferably greater than or equal to 1.0 S·m⁻¹ and especially preferably greater than or equal to 1.10³ S·m⁻¹.

The metal oxide is titanium oxide, for example, but any other transparent conductive oxide (TCO) or metal oxide could be used. Any organic binder making it possible to bind together the oxide could be chosen, provided that the coating 12 has the transparency and conductivity characteristics stated above.

The coating 12 described here is known and conventionally employed to coat the surface of a touch-sensitive screen, for example equipping touch-screen tablet computers. Reciprocally, the person skilled in the art could use such a known coating, conventionally employed to coat a touch-sensitive screen, to deposit it on the first wall of the lighting device 2.

The coating 12 has a thickness less than 10 μm and preferably greater than 100 nm. This order of magnitude of the thickness of the coating 12 makes it possible to achieve a good compromise between the effectiveness of the electromagnetic shielding, which increases with the thickness of the coating 12, and the mechanical strength of the coating 12, the durability of which increases as the thickness of the coating 12 decreases.

The coating 12 may be deposited on the first wall by any known thin layer deposition process, such as dipping, spraying or centrifuging. These processes being known, they will not be further described hereinafter.

Because the coating 12 is electrically conductive, the lighting device 2 comprises at least one first wall delimiting an area on which or in which the electric element 6 is retained. This first wall, formed by a wall of the casing 4, is at least partly covered with the electrically conductive coating 12 forming electromagnetic shielding limiting the magnetic field diffused by the electric element 6 outside the lighting device 2. In fact, electrically conductive materials have the property of reflecting electromagnetic waves that encounter those materials. Thus any electromagnetic ray emitted by the electric conductors 6 encountering the coating 12 is reflected, which makes it possible to prevent irradiating and causing interference to the electric devices generally equipping the vehicle and situated outside the lighting device 2.

In accordance with a variant of this first embodiment of the invention shown in FIG. 3, the electric element 6 is retained on an electric connection substrate 13 housed in the casing 4. This electric connection substrate 13 takes the form of a printed circuit board, for example. The first wall, i.e. the surface of the lighting device 2 covered with the coating 12, is then formed by at least a portion of this electric connection substrate 13, and not by the internal surface 10 of the casing 4. This electric connection substrate 13 carries the light sources of the optical means 8 and forms an interface between the light sources and the electric conductors 6. The electric connection substrate 13 covered with the coating 12 is therefore situated in the vicinity of the electric conductors 6. Moreover, the electric connection substrate 13 itself emits electromagnetic rays, which are confined by the coating 12. The electric connection substrate 13 covered with the electrically conductive coating 12 therefore provides effective electromagnetic shielding of the lighting device 2.

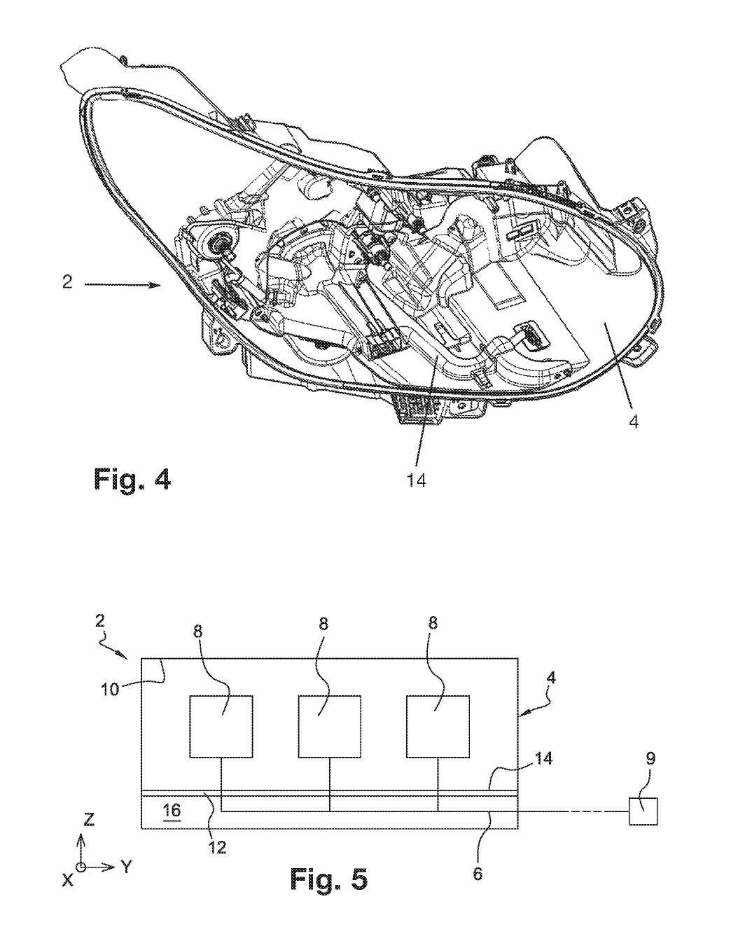

There is shown in FIGS. 4 to 6 the lighting device 2 in accordance with a second embodiment of the invention. This second embodiment differs from the first in that the casing 4 further contains a guide element 14 for guiding the path of the electric conductors 6 in the casing 4. This guide element 14 makes it possible to form a confinement housing 16 in the casing 4 in which the electric conductors 6 partially lie. A portion of the conductors 6 can therefore lie only in a restricted area of the casing 4, as can notably be seen in FIG. 5. This constitutes the guiding of the electric conductors 6 in the casing 4.

The guide element 14 is intended to be associated with at least a portion of the casing 4 of the lighting device 2 in order to form a closed assembly inside which the electric conductors are positioned. The guide element 14 therefore forms with the associated portion of the casing 4 a protective element completely surrounding in its cross section at least a longitudinal portion of the electric conductors 6.

The guide element 14 may be fixed to the internal surface 10 of the casing 4 of the lighting device 2 by any retaining means well known to the person skilled in the art.

The guide element 14 may preferably be of the exoskeleton type.

By the term “exoskeleton” is meant an element external to, i.e. structurally independent of, the electric conductor(s) of the invention. The exoskeleton makes it possible at least in part to support and to protect mechanically the electric conductor(s) of the invention.

The exoskeleton may have a substantially constant thickness around the electric conductor(s) that it partly surrounds. For example, the thickness of the exoskeleton is between 1 mm and 3.5 mm inclusive.

The guide element 14 may further comprises at least one first opening intended to allow at least one electric connector to pass through it.

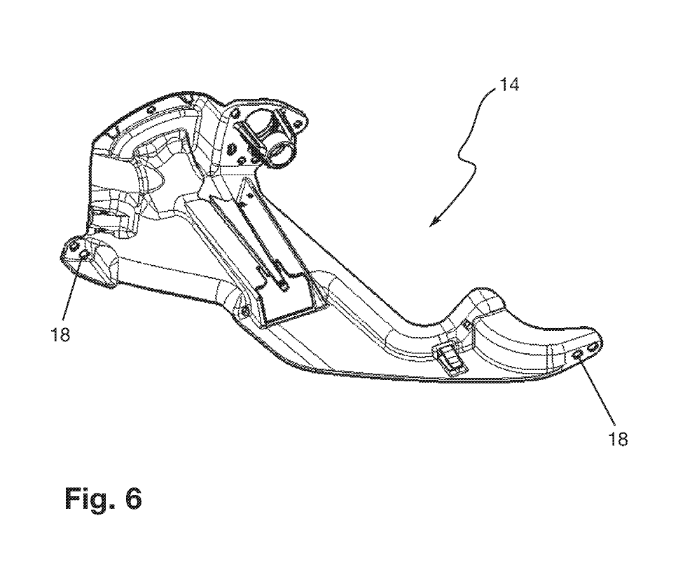

The guide element 14 may further comprise at least one second opening intended to enable the fixing of the guide element 14 to the internal surface 10 of the casing 4 of the lighting device 2. As can be seen in FIG. 6, the guide element 14 includes such openings 18. These openings 18 are adapted to cooperate with fixing means (not shown) well known to the person skilled in the art intended to fix the guide element 14 to the casing 4 of the lighting device 2. In other words, the guide element 14 is mounted on the casing 4, inside the casing 4. The fixing may be effected by screwing, gluing or riveting, for example.

The guide element 14 may be an envelope completely surrounding at least a longitudinal portion of the electric conductor or conductors 6.

In other words, the guide element 14 comprises an envelope longitudinally closed over the portion of the electric conductor or conductors 6 to be protected. To be more specific, the guide element 14 has a closed surface in cross section. This may be referred to as a closed protection envelope.

The guide element 14 may preferably be of the cylindrical type and may preferably have a substantially constant thickness all around the electric conductor or conductors 6. For example, the thickness of the guide element 14 is between 0.3 mm and 1.0 mm inclusive. The protective envelope can therefore be of the protective sheath type.

The exoskeleton type guide element 14 may also be combined with the protective sheath type guide element 14. In this case, the protective sheath is situated inside the exoskeleton.

The second embodiment further differs from the first in that the first wall is formed by a wall of the guide element 14 and not by a portion of the internal surface 10 of the casing 4. As can be seen in FIG. 5, the electric conductors 6 are situated in the vicinity of the wall of the guide element 14 covered with the coating 12 by virtue of the guiding of the electric conductors 6. It is the side of the wall of the guide element 14 that is oriented toward the confinement housing 16 that is provided with the coating 12. The coating 12 is therefore effective at reflecting the electromagnetic rays emitted by the electric conductors 6.

By way of a variant of this second embodiment, the lighting device 2 may further comprise a second wall at least partially covered with the coating 12, the first wall being part of the guide element 14 and the second wall being part of a portion of the casing 4 of the lighting device 2. These first and second walls delimit the confinement housing 16 in which the electric conductors 6 are retained. In other words, all the walls that form the confinement housing 16 are coated. In this way, any electromagnetic field emitted by the electric conductors 6 in the confinement housing 16 encounters the coating 12 and is reflected. The electromagnetic fields are therefore confined in the confinement housing 16, which then forms a Faraday cage.

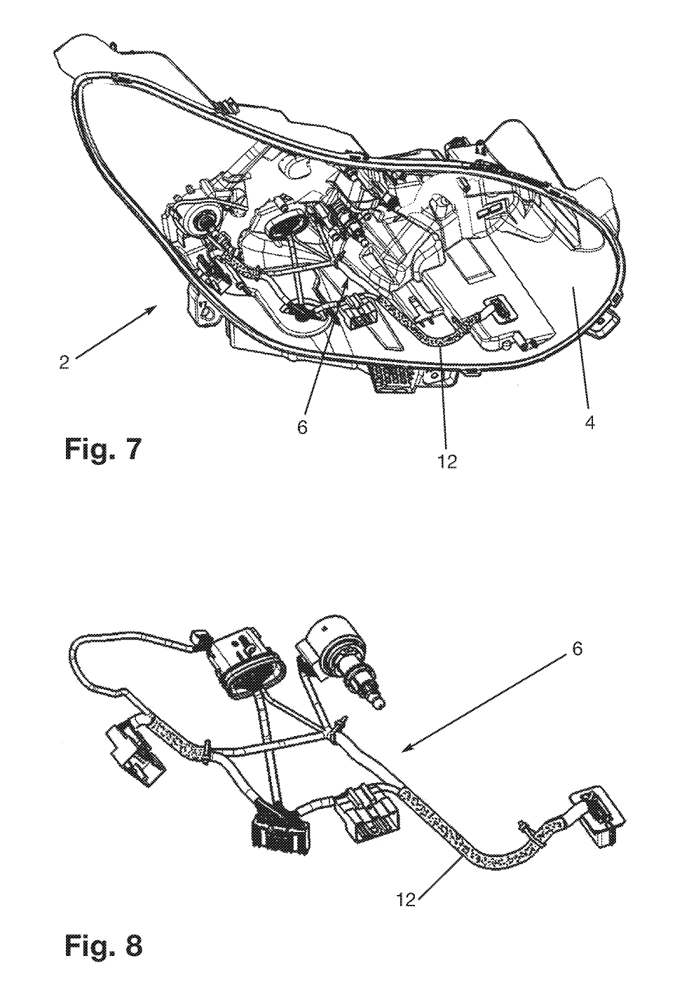

There is shown in FIGS. 7 and 8 the lighting device 2 in accordance with a variant of the invention applicable to the first and second embodiments described above. In accordance with this variant, the electric element 6 comprises electric conductors 6 partially enveloped in an insulative sheath covered with the coating 12. The coating 12 is deposited on the external surface of the insulative sheath in order to prevent short-circuits with the electric conductors 6. This sheath can notably be seen in FIG. 8. Given that the sheath is situated in the vicinity of the electric conductors 6, the sheath provide effective electromagnetic shielding.

The variant embodiment shown in FIGS. 7 and 8 is applicable with the first and second embodiments described above. This means that the lighting devices 2 of these first and second embodiments, shown in FIGS. 1 and 4, respectively, may comprise electric conductors 6 at least partly enveloped in an insulative sheath covered with the coating 12.

Of course, numerous modifications may be made to the invention without departing from the scope of the latter.

The distribution of the coating 12 on the wall or walls may be different to what is described above and shown in the drawings.

The lighting device 2 may have a different architecture such that the guide element 14 carries directly or indirectly a light source disposed outside the confinement housing 16. In this way, the portion of the connectors supplying the light source or sources with electrical energy that enters the casing 4 of the optical unit lies entirely inside the confinement housing 16. Providing the walls forming the confinement housing 16 with the electrically conductive coating ensures that the electromagnetic rays emitted by the connectors are confined in the confinement housing 16.

In each of the embodiments described, the lighting device 2 could comprise a plurality of electric elements 6 forming electric conductors, the shielded wall being common to those conductors. The internal surface of the casing 4 of the lighting device 2 could also be entirely covered with the electrically conductive coating 12.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A motor vehicle lighting device comprising at least one electric element and at least one first wall delimiting an area on which or in which said at least one electric element is retained, said at least one first wall being at least partly covered with an electrically conductive coating forming electromagnetic shielding.

2. The motor vehicle lighting device as claimed in claim 1, wherein said at least one electric element comprises an electric conductor.

3. The motor vehicle lighting device as claimed in claim 1, wherein said electrically conductive coating is transparent to visible light.

4. The motor vehicle lighting device as claimed in claim 1, wherein said electrically conductive coating comprises at least one metal oxide.

5. The motor vehicle lighting dvice as claimed in claim 4, wherein said electrically conductive coating comprises at least one organic binder for binding together said at least one metal oxide.

6. The motor vehicle lighting device as claimed in claim 1, wherein electrical conductivity of said electrically conductive coating is greater than or equal to 1.10⁻³ S·m⁻¹, preferably greater than or equal to 0.1 S·m⁻¹, preferably greater than or equal to 1.0 S·m⁻¹ and especially preferably greater than or equal to 1.10³ S·m⁻¹.

7. The motor vehicle lighting device as claimed in claim 1, wherein said at least one first wall conductive coating has a thickness less than 10 μm.

8. The motor vehicle lighting device as claimed in claim 1, wherein said at least one first wall is made of a polymer covered with said electrically conductive coating.

9. The motor vehicle lighting device as claimed in claim 1, wherein said lighting device comprises a casing said, said at least one first wall being at least a part of said casing.

10. The motor vehicle lighting device as claimed in claim 1, wherein said lighting device comprises an electric connection substrate adapted to be connected to said at least one electric element, said at least one first wall being formed by said electric connection substrate.

11. The motor vehicle lighting device as claimed in claim 1, wherein said at least one electric element comprises at least one electric conductor and is at least in part on a guide element for guiding a path of said at least one electric conductor, said at least one first wall being at least in part formed by said guide element.

12. The motor vehicle lighting device as claimed in claim 11, comprising a second wall at least partly covered with an electrically conductive coating, said at least one first wall being part of said guide element and said second wall being part of a portion of a casing of said lighting device, said at least one first wall and said second wall delimiting a confinement housing in which said at least one electric conductor is retained.

13. The motor vehicle lighting device as claimed in claim 1, comprising a plurality of electric elements forming electric conductors, said at least one first wall being common to said electric conductors.

14. The motor vehicle lighting device as claimed in claim 13, wherein said plurality of electric elements are at least partly covered with an electrically conductive coating.

15. The motor vehicle lighting device as claimed in claim 2, wherein said electrically conductive coating is transparent to visible light.

16. The motor vehicle lighting device as claimed in claim 2, wherein said electrically conductive coating comprises at least one metal oxide.

17. The motor vehicle lighting device as claimed in claim 2, wherein electrical conductivity of said electrically conductive coating is greater than or equal to 1.10⁻³ S·m⁻¹, preferably greater than or equal to 0.1 S·m⁻¹, preferably greater than or equal to 1.0 S·m⁻¹ and especially preferably greater than or equal to 1.10³ S·m⁻¹.

18. The motor vehicle lighting device as claimed in claim 4, wherein electrical conductivity of said electrically conductive coating is greater than or equal to 1.10⁻³ S·m⁻¹, preferably greater than or equal to 0.1 S·m⁻¹, preferably greater than or equal to 1.0 S·m⁻¹ and especially preferably greater than or equal to 1.10³ S·m⁻¹.

19. The motor vehicle lighting device as claimed in claim 2, wherein said electrically conductive coating has a thickness less than 10 μm.

20. The motor vehicle lighting device as claimed in claim 4, wherein said electrically conductive coating has a thickness less than 10 μm.
